(19) United States
(12) Patent Application Publication
(10) Pub. No.: US 2024/0235087 A1
(43) Pub. Date: Jul. 11, 2024

(54) ELASTIC ELECTRIC CONTACT TERMINAL IN WHICH CRACKS IN METAL LAYER ARE PREVENTED

(71) Applicant: JOINSET CO., LTD., Ansan-si (KR)

(72) Inventors: Sun-Ki Kim, Gunpo-si (KR); Byung-Joo Park, Ansan-si (KR); Jin-San Kim, Ansan-si (KR); Hyoung-Kyu Kim, Ansan-si (KR)

(21) Appl. No.: 18/409,767

(22) Filed: Jan. 10, 2024

(30) Foreign Application Priority Data
Jan. 11, 2023 (KR) 10-2023-0004142
Dec. 27, 2023 (KR) 10-2023-0193235

(51) Int. Cl. H01R 13/24; H01R 12/57

(52) U.S. Cl. CPC H01R 13/2407; H01R 12/57

(57) ABSTRACT

An elastic electric contact terminal having a structure capable of preventing cracks in the longitudinal direction of a metal layer as much as possible when pressed from top to bottom is disclosed. The electric contact terminal includes: first and second elastic cores each having an upper wall, a lower wall, and a sidewall connecting the upper wall and the lower wall, and having an opening formed on an opposite side of the sidewall; a heat-resistant polymer film that surrounds the upper wall, lower wall, and opening of each core, and is adhered to at least the upper and bottom surfaces of each core via an elastic adhesive; and a metal layer formed on the outer surface of the polymer film. On a side where the opening is formed, the metal layer of each core is adhered to each other through an adhesive layer.

### REFERENCE TO RELATED APPLICATIONS

This application claims the priority benefit of Korean Patent Application No. 10-2023-0004142 filed on Jan. 11, 2023 and Korean Patent Application No. 10-2023-0193235 filed on Dec. 27, 2023, the entire contents of which are incorporated herein by reference.

### FIELD OF THE INVENTION

The present invention relates to an elastic electric contact terminal, and more particularly, to an elastic electric contact terminal having a structure that minimizes an occurrence of cracks in a metal layer.

### BACKGROUND OF THE INVENTION

Recently, as the frequency of electronic communication devices and the semiconductors used therein has increased, the need for elastic electric contact terminals that connect opposing objects with low electrical resistance at a short distance is increasing.

An electric contact terminal with such elasticity is inserted between opposing objects and plays the role of transmitting electricity to opposing objects by pressing. For example, it is mounted on a circuit board and serves to electrically connect the circuit board to an electrically conductive object located in a direction opposite to the circuit board.

As shown in FIG. 1A, looking at the structure of the electric contact terminal of Korea Patent Registration No. 1001354 by the present applicant, a metal layer 40, which is interposed between opposing objects and transmits electricity in the vertical direction, is formed to cover and adhere to a sidewall exposed to the outside of an elastic core 10. If pressing the bottom of the electric contact terminal soldered to the circuit board a lot or repeatedly from the top to the bottom, disadvantageous damage to the metal layer formed on the sidewall in the height direction may occur in the longitudinal direction, resulting in longitudinal cracks in the metal layer, which may increase electrical resistance or cause a short circuit.

That is, when the bottom of the electric contact terminal is fixed to the circuit board by solder and the electric contact terminal is pressed from top to bottom, the side of the electric contact terminal opens outward. When the bottom of the metal layer is fixed in a soldered state and the electric contact terminal is pressed a lot or repeatedly from the top to the bottom, cracks occur in the metal layer in the longitudinal direction on the side of the electric contact terminal, increasing the electrical resistance.

In particular, when solder is formed along the sidewall from the bottom of the electric contact terminal to improve soldering strength, there is a disadvantage in that cracks in the metal layer become more severe along a boundary line where the upper end of the solder and the metal layer meet.

In addition, because the polymer film with the metal layer formed thereon is adhered to the entire sidewall of the core with an adhesive, there is a disadvantage in that the pressing force and recovery rate inherent to the core are modified by the adhesive and the polymer film.

To solve this problem, looking at Republic of Korea Patent No. 2324261, as shown in FIG. 1B, a non-conductive coating layer is formed to cover the upper and bottom surfaces and both sides of the elastic core, and a space is formed between the elastic core and the non-conductive coating layer on both sides of the elastic core. In particular, a space is formed in a portion, and for this purpose, the non-conductive coating layer, that is, the adhesive layer, is not adhered to the core in that portion but protrudes convexly.

As such, there is a disadvantage in that it is difficult during the manufacturing process to prevent the non-conductive coating layer from sticking to the core because the non-conductive coating layer protrudes convexly at a uniform location in some parts.

For example, since a liquid non-conductive coating layer is cast to a uniform thickness on a polymer film and then continuously passes through the mold to cover the sidewalls of the core, some of the sidewalls of the core protrude convexly, making it difficult to manufacture them while they do not adhere to the core, and it is difficult to control the size and location of the space.

In addition, if the core is pressed too much, it opens not only in the space, but also opens sideways overall. The space formed by the convex protrusion of the non-conductive coating layer limited to a portion is difficult to accommodate all the compression of the core in various directions, and the metal layer may be damaged in that area.

In this way, if a conventional electric contact terminal with elasticity is pressed a lot or repeatedly, there are disadvantages in that 1) cracks may occur along the longitudinal direction in the metal layer that electrically connects the object, 2) while electrical resistance is low at the closest distance, there are limitations in connecting objects, and 3) there are limitations in providing the compression force or recovery rate that the core originally possesses.

### SUMMARY OF THE INVENTION

An object of the present invention is, to solve the above conventional problems, to provide a reliable and economical elastic electric contact terminal having a structure of various cross-sections and shapes, wherein when an electric contact terminal is mounted and fixed on an object by soldering and is repeatedly pressed or repeatedly pressed from the top to the bottom by another opposing object, the structure minimizes the stress provided in the longitudinal direction of the electrically conductive film, minimizes the occurrence of cracks in the longitudinal direction of the electrically conductive film, and connects objects with low electrical resistance.

Another object of the present invention is to provide an elastic electric contact terminal capable of providing electricity to an opposing object over the shortest distance.

Another object of the present invention is to provide an elastic electric contact terminal in which the compression range from the top to the bottom is large while reducing the occurrence of cracks in the electrically conductive film, and in which the difference from the original compressive force or restoration force of the core may be minimized.

Another object of the present invention is to provide an elastic electric contact terminal in which the cores are not separated from each other when pressed from upward to downward while minimizing the occurrence of cracks in the longitudinal direction of the electrically conductive film.

Another object of the present invention is to provide an elastic electric contact terminal that facilitates reflow soldering using vacuum pickup and solder cream and minimizes the occurrence of cracks in the longitudinal direction of the electrically conductive film after soldering.

According to an aspect of the present invention, there is provided an elastic electric contact terminal that is interposed to be pressed between opposing objects so as to electrically connect the objects to each other, the electric contact terminal comprising: first and second cores arranged horizontally to be coupled to each other and having elasticity; and an electrically conductive film comprising an upper contact portion adhered to at least one of top surfaces of the first and second cores, a lower contact portion adhered to at least one of bottom surfaces of the first and second cores, and a connection portion integrated with the upper and lower contact portions and adhered to outer surfaces of the first and second cores between the first and second cores, wherein each of the contact portion and the connection portion has electrical conductivity.

Each of the first and second cores may have a through-hole defined along a longitudinal direction, the electrically conductive film may be adhered to the top and bottom surfaces of each of the first and second cores, and the outer surfaces of adjacent sidewalls of the first and second cores, respectively, with an adhesive, and in the adjacent sidewall portions, the electrically conductive films may be adhered to each other by an adhesive layer.

An opening communicating with the through-hole may be defined in the adjacent sidewall of at least one of the first and second cores.

A height of the opening may be equal to or smaller than that of the adjacent sidewall.

The sum of thicknesses of the adjacent sidewalls may be less than thickness of each of other non-adjacent sidewalls.

When the electric contact terminal is pressed by the object, the adjacent sidewalls may be not spread by the adhesive layer.

The cross-sectional shapes of the first and second cores may be symmetrical to each other.

Heights of the first and second cores may be different from each other.

The upper contact portion may extend downward along the outer surface of the core, the lower contact portion may extend upward along the outer surface of the core, or both.

The first core may have a tube shape, and the second core may have a sheet shape that is narrower than the first core or may be a coating layer adhered to the connection portion of the electrically conductive film.

The electrically conductive film may be provided as a metal layer disposed on a polymer film, and the polymer film may be adhered to the core by the adhesive.

The electrically conductive film may be provided as a metal layer disposed on a polymer film, and the electric contact terminal may be capable of vacuum pickup and reflow soldering using solder cream.

Each of the first and second cores may have a through-hole defined along a longitudinal direction, the electrically conductive film may be provided as a single body, the upper contact portion may be adhered to the top surface of the first core by an adhesive, the lower contact portion may be adhered to the bottom surface of the second core by the adhesive, and each of both sides of the connection portion may be adhered to each of the outer surfaces of adjacent sidewalls of the first and second cores by the adhesive.

When the electric contact terminal is pressed from top to bottom, the connection portion of the electrically conductive film may be bent.

### BRIEF DESCRIPTION OF THE DRAWINGS

The above objects and other advantages of the present invention will become more apparent by describing in detail exemplary embodiments thereof with reference to the attached drawings in which:

FIGS. 1A and 1B each show an electric contact terminal according to a related art;

FIG. 2 shows a state in which an elastic electric contact terminal is mounted according to an embodiment of the present invention;

FIG. 3 shows the electric contact terminal in a separated state;

FIG. 4 shows the state in which the elastic electric contact terminal is mounted;

FIG. 5 shows a single electrically conductive film applied to an elastic electric contact terminal;

FIG. 6 shows an elastic electric contact terminal according to another embodiment of the present invention;

FIG. 7 shows an elastic electric contact terminal according to another embodiment of the present invention; and

FIGS. 8A and 8B show an elastic electric contact terminal according to a modified example of the present invention.

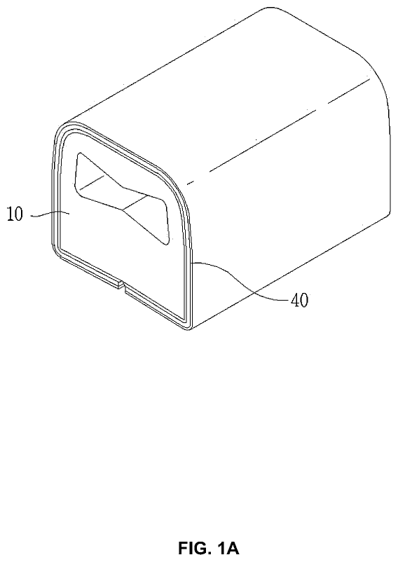

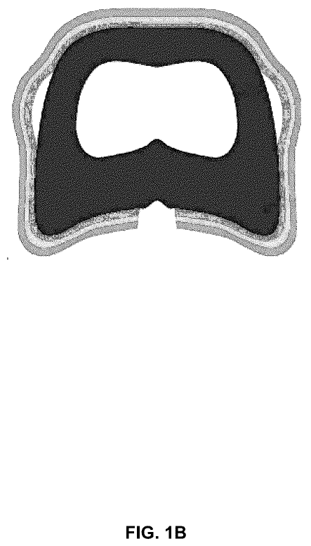

### DETAILED DESCRIPTION OF THE INVENTION

It should be noted that the technical terms used in the present invention are only used to describe specific embodiments and are not intended to limit the present invention. In addition, the technical terms used in the present invention, unless specifically defined in a different sense in the present invention, should be interpreted as meanings generally understood by those skilled in the art to which the present invention pertains, and should not be interpreted in an overly comprehensive or overly narrow sense.

Hereinafter, specific embodiments of the present invention will be described in detail with reference to the attached drawings.

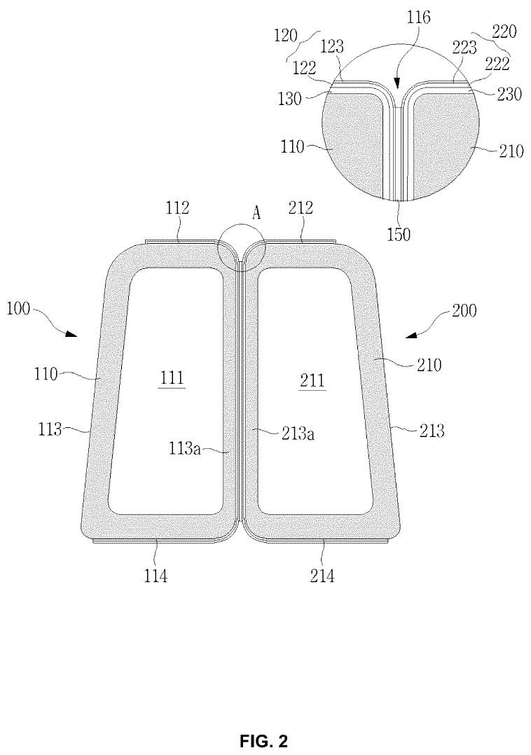

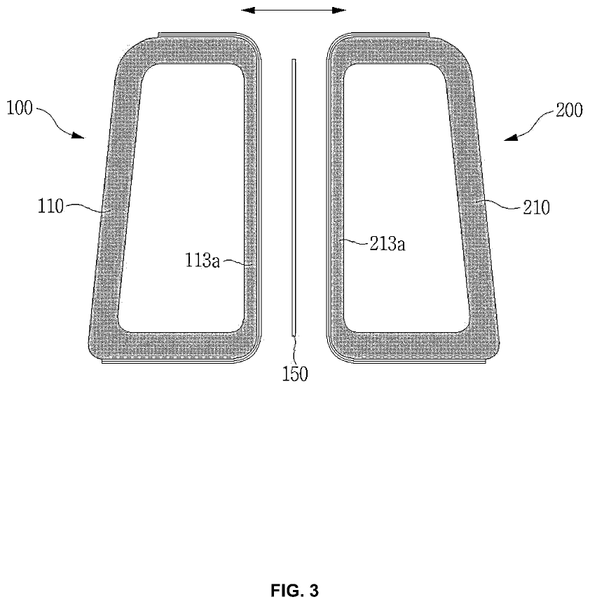

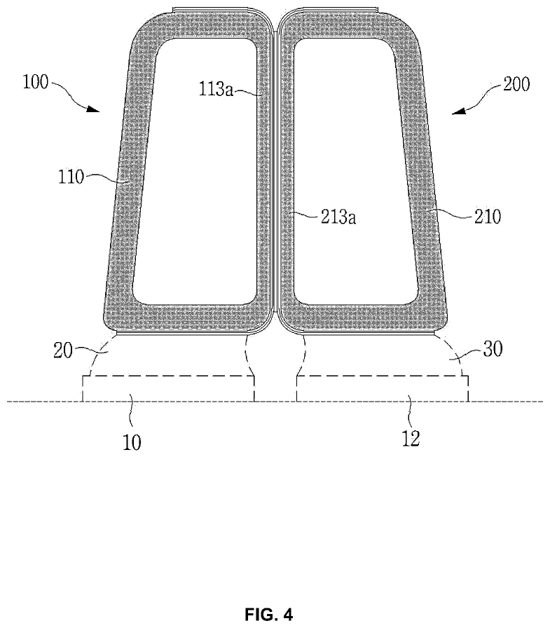

FIG. 2 shows an elastic electric contact terminal according to an embodiment of the present invention, FIG. 3 shows the elastic electric contact terminals separated from each other, and FIG. 4 shows an elastic electric contact terminal mounted on a circuit board by soldering.

The elastic electric contact terminal of the present invention has a structure in which the first unit 100 and the second unit 200 are horizontally adjacent and adhered to each other.

An adhesive layer 150 is interposed at a portion where first and second units 100 and 200 are adjacent to each other and are in contact with each other. When the electric contact terminal is pressed from top to bottom, the first and second units 100 and 200 have adhesive strength such that they do not open or separate from each other.

In addition, when the first and second units 100 and 200 have a certain radius of curvature at the upper and lower portions of the adhesive layer 150, a gap 116 is created. It is desirable to keep the separation as small as possible to facilitate vacuum pickup of the electric contact terminal.

The first and second units 100, 200 include an elastic core 110, 210 with through-holes 111, 211 defined along the longitudinal direction (the direction going into the ground in the drawing), and electrically conductive films 120, 220 adhered to the outer surfaces of the cores 110, 210 via elastic adhesives 122, 222. The exposed outer surfaces of the electrically conductive films 120 and 220 are electrically conductive.

The electric contact terminal preferably allows vacuum pickup on the upper side and reflow soldering using solder cream on the lower side, but is not limited thereto.

The cores 110 and 210 are preferably made of elastic silicone rubber with heat resistance corresponding to the soldering temperature, but are not limited thereto.

The cores 110 and 210 are preferably made of elastic rubber formed by extrusion and curing, but are not limited thereto, and may more preferably have the same or similar dimensions, but are not limited thereto and may have some different dimensions.

The cores 110 and 210 are provided as an upper wall and a lower wall centered on the through-holes 111 and 211, respectively, and a pair of sidewalls 113, 113a, 213, and 213a connecting the upper wall to the lower wall.

The adhesives 130 and 230 are preferably silicone rubber adhesives having elasticity and elasticity formed by curing a liquid silicone rubber adhesive, and in this embodiment, the electrically conductive films 120 and 220 corresponding to each unit 100 and 200 are adhered to the outer surfaces of the cores 110 and 210 for each unit 100 and 200 using adhesives 130 and 230.

In the following description, for convenience of understanding, the sidewalls 113a and 213a that are adjacent to each other when the units 100 and 200 are arranged horizontally are defined as “adjacent sidewalls.”

In this embodiment, the electrically conductive films 120 and 220 are adhered to the outer surfaces of the adjacent sidewalls 113a and 213a of each core 110 and 210 using adhesives 130 and 230, and the first and second units 100 and 200 are adhered to each other by adhering the electrically conductive films 120 and 220 to each other via an adhesive layer 150 interposed therebetween.

Preferably, the sum of the thicknesses of adjacent sidewalls 113a and 213a is provided to be thinner than the thickness of one non-adjacent sidewall 113 and 213. Thus, when the electric contact terminal is pressed from top to bottom, the electrically conductive films 120, 220 provided here are bent or open well to the side.

The adhesive layer 150 is preferably a silicone rubber adhesive having elasticity and elasticity formed by curing a liquid silicone rubber adhesive.

The adhesive layer 150 may be electrically insulating for better elasticity and adhesion. In this case, there is an advantage in that the electrically conductive film 120 of the first unit 100 and the electrically conductive film 220 of the second unit 200 may be electrically separated from each other and may serve as two electric contact terminals.

The adhesive layer 150 may be elastic and electrically conductive. In this case, the electrically conductive film 120 of the first unit 100 and the electrically conductive film 220 of the second unit 200 are electrically connected to each other and may serve as one electric contact terminal.

In this embodiment, the electrically conductive films 120 and 220 include each electric contact part that electrically contacts the object on the upper and bottom surfaces of each core 110, 210 and a connection part that passes between each core 110, 210, and have a structure that is adhered to the outer surface of each core 110, 210.

The electrically conductive films 120 and 220 may be metal foils or electrically conductive fibers, or, as in this embodiment, metal layers 123 and 223 may be disposed on the outer surfaces of the polymer films 122 and 222. An electrically conductive film in which a metal layer is disposed on the outer surface of a metal foil or a polymer film corresponding to a soldering temperature may be applied when soldering is required.

The electrically conductive film 120, 220, in which a metal layer is disposed on the outer surface of the polymer film, has the advantage of having a greater tensile strength than a metal foil and being less deformed by external pressure due to the polymer film 122, 222.

The metal layers 123 and 223 disposed on the outer surfaces of the polymer films 122 and 222 may be formed by sputtering metal and plating copper on the polymer films 122 and 222, formed by casting liquid polymer resin on copper foil and then curing it, or provided by adhering the copper foil to the polymer films 122 and 222 with another adhesive.

Here, tin, nickel, and gold may be sequentially plated on the metal layers 123 and 223 for environmental resistance and soldering using solder cream.

When the externally exposed portion of the metal layer 123, 223 of the electrically conductive film 120, 220 is plated, soldering is easy and corrosion is prevented. Manufacturing costs may be reduced by not plating the metal layer of the electrically conductive film attached to the outer surface of the adjacent sidewall.

Although not limited, the total thickness of the electrically conductive films 120 and 220 may be approximately 7 μm to 35μm, and the thickness of the adhesives 130 and 230 may be approximately 10 μm to 30μm, which may vary depending on the characteristics of the electric contact terminal.

According to this structure, when the electric contact terminal is pressed from the top to the bottom by an external force, the adjacent sidewall is easily bent. The electrically conductive film adhered to the outer surface of the adjacent sidewall may also be bent or open laterally along the sidewall to minimize stress, thereby minimizing the occurrence of cracks in the longitudinal direction of the electrically conductive film located here.

In addition, since no electrically conductive film is disposed on the outer surfaces of the left and right sidewalls exposed to the outside of the core, the compressive force of the electric contact terminal may be reduced and the recovery rate is good. In other words, it is easy to minimize the difference between the pressing force or recovery rate of the electric contact terminal itself and the pressing force or recovery rate of the core itself.

In addition, since the electrically conductive film that provides the electrical passage is adhered along the outer surface of the adjacent sidewall between the cores, opposing objects may be electrically connected at the shortest distance, and two electrically conductive films are located in this part, allowing opposing objects to be connected with lower electrical resistance.

In this way, when the electric contact terminal is pressed by an object, there is an advantage that cracks in the longitudinal direction of the electrically conductive film that electrically connects the object are minimized, and the object may be electrically connected with low electrical resistance.

Looking at FIG. 4, when the electric contact terminal, which is provided as the first and second units 100, 200 facing each other and adhered by another adhesive layer 150, is vacuum picked up from the top surface of the electrically conductive film 120 and 220 and the bottom surfaces of the electrically conductive films 120 and 220 are placed on the solder cream on the conductive patterns 10 and 12 disposed on the circuit board and reflow soldered, as is well known, the molten liquid solder cream is cooled between the bottom surface of the electrically conductive film 120 and 220 and the conductive pattern 10 and 12 to form a solid solder layer 20 and 30 and soldered to the circuit board.

Here, when the electric contact terminal is reflow soldered, to allow the electric contact terminal to be normally soldered in the correct position on the conductive pattern, preferably, the first and second units 100 and 200 may be approximately symmetrical with respect to a vertical line crossing the adhesive layer 150, but the present invention is not limited thereto.

According to this structure, the first and second units 100 and 200 are adhered to each other through another adhesive layer 150 to form a single unit. Thus, when the electric contact terminal is pressed from the top to the bottom, the cores 110, 210 may be pressed simultaneously in an integrated shape, and preferably, the electrically conductive films 120 and 220 are located at the center of the electric contact terminal so that electricity may be provided over the shortest distance between opposing objects.

Preferably, the width and height of the first and second units 100 and 200 are the same so that they may be balanced to facilitate surface mounting, but they are not limited thereto and may have different widths and heights.

In addition, the width of the bottom surface of the cores 110 and 210 is provided to be larger than the width of the top surface, and as a result, the width of the bottom surface of the electric contact terminal provided as the first and second units 100 and 200 is provided to be larger than the width of the top surface. Thus, when the electric contact terminal is reflow soldered, there is less movement, allowing reliable surface mounting.

In addition, the thickness of the lower wall of the cores 110 and 210 is thicker than the thickness of the upper wall, or the volume of the lower wall of the cores 110 and 210 is larger than the volume of the upper wall, to provide reliable surface mounting while improving the resilience of electric contact terminals.

According to this embodiment, the electrically conductive films 120 and 220 have a structure in which the cores 110 and 210 are adhered only to the top surface, adjacent sidewalls, and bottom surfaces of the cores 110 and 210, so that soldering is done only at the bottom of the electric contact terminal and no solder layer is disposed on the sidewall. As a result, the compression force of the electric contact terminal may be lowered and the restoration rate may be improved.

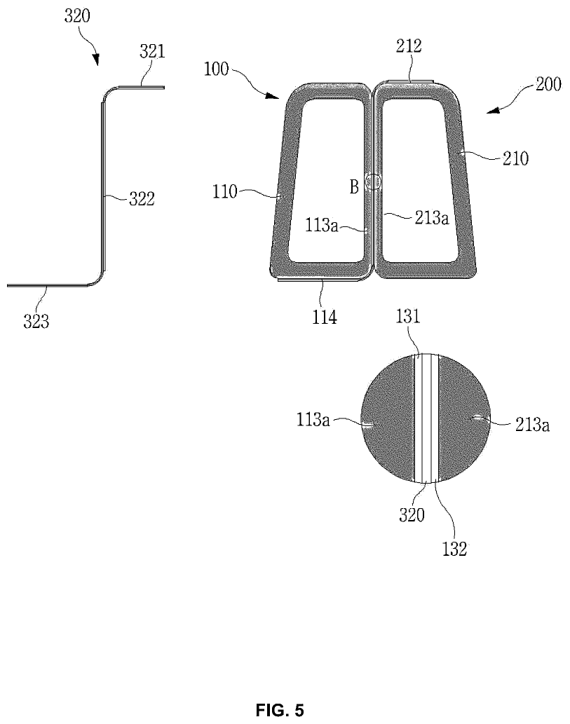

FIG. 5 shows an elastic electric contact terminal using a single electrically conductive film.

This embodiment shows a structure in which a common, single electrically conductive film 320 is used between the first and second units 100 and 200.

A single electrically conductive film 320 comprises an upper contact portion 321 that covers and adheres to the top surface 212 of the core 210, a lower contact portion 323 that covers and adheres to the bottom surface 114 of the core 110, and a connection portion 322 integrated with the upper and lower contact portions 321 and 323 and adhered to the outer surface of the cores 110 and 210 between the cores 110 and 210.

As shown in the enlarged circle, a connection portion 322 extends between the adjacent sidewalls 113a and 213a of each core 110 and 210 and is adhered to the adjacent sidewalls 113a and 213a via adhesives 131 and 132, respectively. Thus, when the electric contact terminal is pressed, the first and second units 100 and 200 are prevented from opening.

The upper and lower contact portions 321 and 323 are respectively adhered to the top surface of the core 110 and the bottom surface of the core 210. Importantly, between the adjacent sidewalls 113a, 213a of each core 110, 210, the connection portion 322 of the electrically conductive film 320 is adhered to the outer surface of the adjacent sidewalls 113a and 213a of each core 110 and 210 using adhesives 131 and 132, and thus each unit 100, 200 is tightly adhered to each other.

Preferably, each core 110, 210 has a left and right symmetrical structure to facilitate surface mounting.

Although not shown, an opening is defined in at least one of the through-holes of each core 110 and 210, so that the pressing force may be reduced or the pressing range may be increased compared to an electric contact terminal without an opening.

According to this embodiment, the electrically conductive film 320 is provided as one continuous single body and has a simple shape that electrically connects objects between objects.

By this structure, the electrically conductive film adhered to the adjacent sidewalls 113a and 213a may minimize the occurrence of cracks in the longitudinal direction and reduce raw material costs.

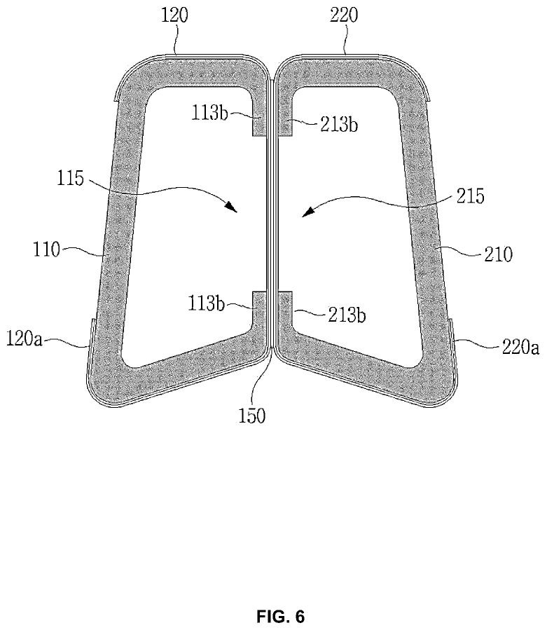

FIG. 6 shows an elastic electric contact terminal according to another embodiment of the present invention.

Openings 115 and 215 communicating with the through-holes 111 and 211 are defined in adjacent sidewalls between the cores 110 and 210. The height of the openings 115 and 215 is preferably such that support sidewalls 113b and 213b are disposed at the top and bottom of the openings 115 and 215, respectively.

In addition, the cross-sectional shape of the bottom surface of the electric contact terminal constituted by the first and second units 100 and 200 is preferably provided in a grooved shape toward the center. Thus, when the electric contact terminal is reflow soldered, the electric contact terminal may be soldered normally in its normal position.

In addition, the electrically conductive films 120 and 220 adhered to the bottom surfaces 114 and 214 of the cores 110 and 210 are partially extended to a certain height along the outer surface, and during reflow soldering, solder rise occurs in the extension portions 120a, 220a, thereby increasing soldering strength.

Likewise, as in this embodiment, the electrically conductive films 120 and 220 adhered to the top surfaces 112 and 212 of the cores 110 and 210 are partially extended downward at a certain height along the outer surface. Thus, it is also possible to provide convenience when actually using an electric contact terminal.

The electrically conductive films 120 and 220 are adhered to the top surface, support sidewalls 113b and 213b and bottom surface of the cores 110 and 210 through an adhesive. Preferably, an elastic adhesive is also attached to the portion of the electrically conductive film corresponding to the portion where the openings 115 and 215 are defined. The mechanical strength and environmental resistance of the electrically conductive films 120 and 220 in this area are improved, and damage or deformation of the electrically conductive films due to external forces or environmental changes may be reduced.

As in one embodiment above, when the elastic adhesive layer 150 is interposed between the electrically conductive films 120 and 220 and each core 110 and 210 are physically combined and pressed from top to bottom, each core 110, 210 may be prevented from opening.

According to this structure, the electrically conductive film portion located in the position corresponding to the opening is protected even if the electric contact terminal is pressed from top to bottom. A core with an opening is more prone to bending or opening to the side with less force than a core without an opening. In this part, the stress applied to the electrically conductive film is minimized, thereby minimizing the occurrence of longitudinal cracks in the electrically conductive film.

In addition, it is easy to have a compression force smaller than that of the electric contact terminal of the embodiment of FIG. 2.

In this embodiment, although not shown, an opening may not be defined in at least one through-hole of each core 110 and 210.

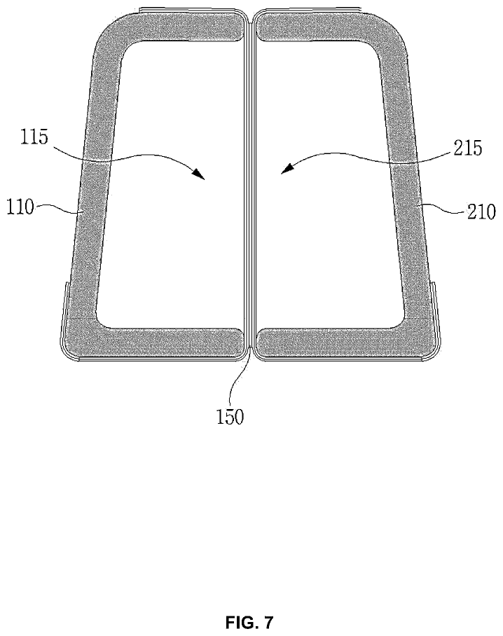

FIG. 7 shows an elastic electric contact terminal according to another embodiment of the present invention.

Compared to the embodiment of FIG. 6, openings 115 and 215 are defined by completely removing adjacent sidewalls of the cores 110 and 210.

The electrically conductive films 120 and 220 are adhered to the upper and bottom surfaces of the cores 110 and 210 through an adhesive. The elastic adhesive is also adhered to the portion of the electrically conductive film corresponding to the portion where the openings 115 and 215 are defined. In this part, the mechanical strength and environmental resistance of the electrically conductive films 120 and 220 are improved, and damage or deformation of the electrically conductive films due to external forces or environmental changes is reduced.

Additionally, in the openings 115 and 215, an elastic adhesive layer 150 is interposed between the electrically conductive films 120 and 220, and as a result, the cores 110 and 210 are physically coupled to each other.

According to this structure, the portion of the electrically conductive film at a position corresponding to the opening is more easily bent or open by the distance that the core is pressed by the opening even if the electric contact terminal is pressed. The provided stress is further minimized, making it easier to minimize the occurrence of cracks in the longitudinal direction of the electrically conductive film.

In addition, the pressing range may be increased compared to the embodiment of FIG. 6 by completely removing the openings 115 and 215.

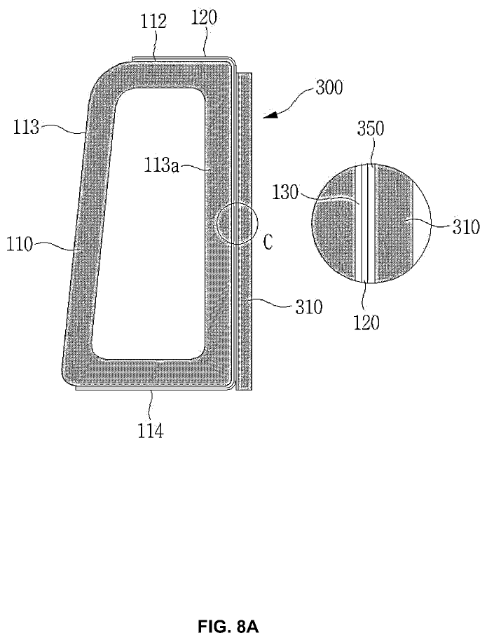

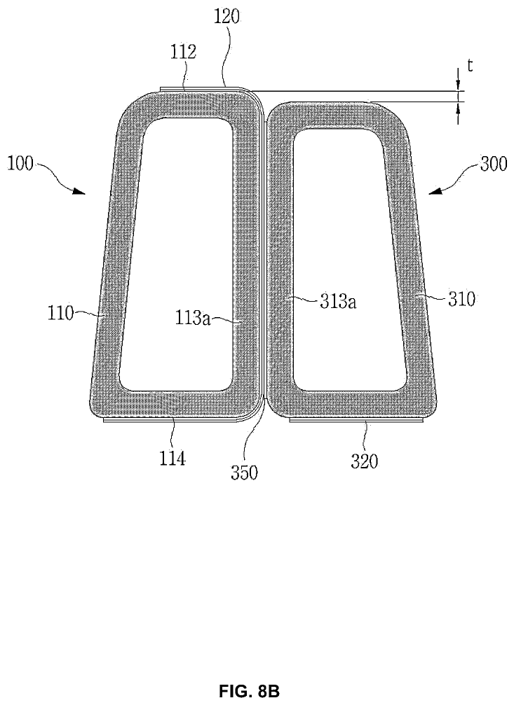

FIGS. 8A and 8B each show an elastic electric contact terminal according to a modified example of the present invention.

Referring to FIG. 8A, the second unit 300 is provided as a sheet-shaped core 310 with a constant thin thickness without a through-hole defined, and a portion of the electrically conductive film 120 adhered to the adjacent sidewall 113a of the core 110 of the first unit 100 is adhered to the core 310 of the second unit 200 through the adhesive layer 350.

The second unit 300 may be provided as only an elastic coating layer with a certain thin thickness, such as a silicone rubber adhesive layer 350. In this case, the adhesive layer 350 itself may function as a core.

Preferably, the second unit 300 may not have an electrically conductive film adhered to the outer surface of the core 310 and serves to partially horizontally support the core 110 of the first unit 100.

Preferably, the width of the second unit 300 is made much smaller than the width of the first unit 100, so that problems that may occur before and after surface mounting may be minimized and manufacturing costs may be reduced.

Although not shown, in order to reduce the pressing force, the core 110 of the first unit 100 preferably has a through-hole in the longitudinal direction in which the opening is defined as in the above embodiment.

Here, the core 310 of the second unit 300 may preferably be provided to have the same or slightly lower height than the core 110.

According to this structure, a portion of the electrically conductive film 120 adhered to the adjacent sidewall 113a of the core 110 of the first unit 100 is adhered to the core 310 of the second unit 200 through the adhesive layer 350. When the electric contact terminal is pressed from top to bottom, the stress provided to the electrically conductive film 120 located in this part is reduced, and thus cracks in the electrically conductive film 120 in the longitudinal direction are reduced.

In addition, since the width of the core 310 of the second unit 200 is narrow, it is easy to provide an electric contact terminal with a small width.

Looking at FIG. 8B, the shape of the core 310 of the second unit 300 has a shape with a through-hole defined in the longitudinal direction, like the core 110 of the first unit 100, and the height of the core 310 may be provided to be smaller than the height of the core 110.

In this case, preferably, the width and shape of the lower part of the core 310 of the second unit 300 are the same or similar to the width and shape of the lower part of the core 110 of the first unit 100 to facilitate surface mounting, but are not limited thereto.

Here, considering symmetrical reflow soldering between cores 110 and 310, the electrically conductive film 320 may be disposed on the bottom surface of the core 310 of the second unit 300, that is, the portion where soldering is performed.

Here, although not shown, an opening may be defined in at least one of the through-holes of the cores 110 and 310 as in the above embodiment.

According to this structure, when the electric contact terminal is pressed from top to bottom, only the high-height core 110 is pressed at first, so that the overall compressive force of the electric contact terminal may be reduced and the pressing distance may be increased. As described in the above embodiment, longitudinal cracks in the electrically conductive film that electrically connects two objects may be minimized.

The electric contact terminal of the present invention is soldered to one object and pressed between opposing objects. Structurally, if the range of pressure from the top to the bottom is relatively large, if the number of repeated pressures is large or if a lot of vibration is provided, for example, if the pressure is pressed more than 20% or if the pressure is repeated more than 100 times, a greater effect may be obtained. However, the use of the electric contact terminal of the present invention is not limited thereto.

In addition, in the above embodiment, at least one of the cores is provided as an example of a tube-shaped rubber with a through-hole in the longitudinal direction. If suitable for the purpose of the present invention, if the core is foam rubber, the through-hole may not be defined.

According to the present invention, even if the electric contact terminal is pressed a lot or repeatedly from top to bottom, an electrically conductive film located between cores operates independently of a pressed core or is easily bent, and thus the stress provided to the electrically conductive film located in this area is minimized, thereby minimizing the occurrence of longitudinal cracks in the electrically conductive film.

In particular, when an opening is defined between the cores, the electrically conductive film bends or opens more easily according to the distance at which the electric contact terminal is pressed in the opening, thereby minimizing stress and minimizing the occurrence of longitudinal cracks in the electrically conductive film.

In addition, the electrically conductive film is located at the shortest distance between opposing objects, so it is possible to provide electricity to opposing objects over the shortest distance, and when two electrically conductive films are used between the cores, electrical resistance may be lowered.

In addition, due to a pair of horizontally arranged and coupled units, the electric contact terminal facilitates vacuum pickup and reflow soldering using solder cream, and has an elastic adhesive layer interposed thereto. Even when the electric contact terminal is pressed from top to bottom, a pair of units may maintain reliable adhesion.

In addition, as an electrically conductive film only on necessary parts of the core is provided, material costs may be reduced, differences from the core's original compressive force or recovery rate may be minimized, and soldering strength may be improved.

In addition, by varying the shape of the core and the structure of the electrically conductive film, it is possible to provide an electric contact terminal with various characteristics.

Although the above description focuses on embodiments of the present invention, various changes may be of course made at the level of those skilled in the art. Therefore, the scope of the present invention cannot be construed as limited to the above-described embodiments, and should be interpreted in accordance with the claims set forth below.

What is claimed is:

1. An elastic electric contact terminal that is interposed to be pressed between opposing objects so as to electrically connect the objects to each other, the electric contact terminal comprising:
first and second cores arranged horizontally to be coupled to each other and having elasticity; and
an electrically conductive film comprising an upper contact portion adhered to at least one of top surfaces of the first and second cores, a lower contact portion adhered to at least one of bottom surfaces of the first and second cores, and a connection portion integrated with the upper and lower contact portions and adhered to outer surfaces of the first and second cores between the first and second cores,
wherein each of the contact portion and the connection portion has electrical conductivity.

2. The elastic electric contact terminal of claim 1, wherein each of the first and second cores has a through-hole defined along a longitudinal direction,
the electrically conductive film is adhered to the top and bottom surfaces of each of the first and second cores, and the outer surfaces of adjacent sidewalls of the first and second cores, respectively, with an adhesive, and
in the adjacent sidewall portions, the electrically conductive films are adhered to each other by an adhesive layer.

3. The elastic electric contact terminal of claim 2, wherein an opening communicating with the through-hole is defined in the adjacent sidewall of at least one of the first and second cores.

4. The elastic electric contact terminal of claim 3, wherein a height of the opening is equal to or smaller than that of the adjacent sidewall.

5. The elastic electric contact terminal of claim 2, wherein the sum of thicknesses of the adjacent sidewalls is less than thickness of each of other non-adjacent sidewalls.

6. The elastic electric contact terminal of claim 2, wherein when the electric contact terminal is pressed by the object, the adjacent sidewalls are not spread by the adhesive layer.

7. The elastic electric contact terminal of claim 1, wherein the cross-sectional shapes of the first and second cores are symmetrical to each other.

8. The elastic electric contact terminal of claim 1, wherein heights of the first and second cores are different from each other.

9. The elastic electric contact terminal of claim 1, wherein the upper contact portion extends downward along the outer surface of the core, the lower contact portion extends upward along the outer surface of the core, or both.

10. The elastic electric contact terminal of claim 1, wherein the first core has a tube shape, and
the second core has a sheet shape that is narrower than the first core or is a coating layer adhered to the connection portion of the electrically conductive film.

11. The elastic electric contact terminal of claim 1, wherein the electrically conductive film is provided as a metal layer disposed on a polymer film, and the polymer film is adhered to the core by the adhesive.

12. The elastic electric contact terminal of claim 1, wherein the electrically conductive film is provided as a metal layer disposed on a polymer film, and
the electric contact terminal is capable of vacuum pickup and reflow soldering using solder cream.

13. The elastic electric contact terminal of claim 1, wherein each of the first and second cores has a through-hole defined along a longitudinal direction,
the electrically conductive film is provided as a single body, the upper contact portion is adhered to the top surface of the first core by an adhesive, the lower contact portion is adhered to the bottom surface of the second core by the adhesive, and each of both sides of the connection portion is adhered to each of the outer surfaces of adjacent sidewalls of the first and second cores by the adhesive.

14. The elastic electric contact terminal of claim 1, wherein when the electric contact terminal is pressed from top to bottom, the connection portion of the electrically conductive film is bent.
